(19) United States
(12) Patent Application Publication
(10) Pub. No.: US 2020/0263672 A1
(43) Pub. Date: Aug. 20, 2020

(54) Frozen Water Energy Generator and Method of Generating Same

(71) Applicants: Ethan Q. Miller, Barrington Hills, IL (US); Thomas A. Miller, Barrington Hills, IL (US)

(72) Inventors: Ethan Q. Miller, Barrington Hills, IL (US); Thomas A. Miller, Barrington Hills, IL (US)

(21) Appl. No.: 16/277,600

(22) Filed: Feb. 15, 2019

(51) Int. Cl. F03G 7/06; C09K 3/18

(52) U.S. Cl. CPC F03G 7/06; C09K 3/185

(57) ABSTRACT

An energy generation device is disclosed which includes a reservoir adapted to receive a supply of water, a spring proximate the reservoir, a supply of calcium chloride, a drive shaft connected to the spring, an electric generator connected to the drive shaft, and a processor, the processor adapted to release the supply of calcium chloride when the supply of water in the reservoir is frozen.

### TECHNICAL FIELD

The present disclosure generally relates to energy generation and, more particularly, relates to devices for generating energy using water.

### BACKGROUND

The world demand for energy continues to increase every year. As the world population expands over time, this trend will only continue to persist. Not only is the world population increasing, but the use of devices and machines such as smart phones, computers, vehicles, and the like per individual is also increasing every year. In addition, more and more houses, housing accommodations, office buildings, commercial spaces and other structures are built every year, each needing energy, heating and cooling.

Traditionally, the majority of such energy has been provided by an energy grid powered by such sources as coal-fired power plants. The use of such fossil fuels have been well-documented as adding to the depletion of the ozone layer and otherwise detrimentally affecting the environment. Even with the use of improved filtering and scrubbing techniques, their use has been shown to have a negative environmental affect. Alternatively, many power plants are nuclear powered, and while effective in generating energy have the detrimental side effects of radioactive waste and the potential for catastrophic melt-downs due to human error or natural disasters such as earthquakes or tsunamis.

As a result of the above, more recently the use of so-called green energy has been increasingly desirable. Such green energy sources include wind power, geo-thermal power and solar power. All produce energy with little to no environmental impact, but themselves have downsides. Geo-thermal power, as it capitalizes on the heat of the earth's core is very expensive to install and extract, often making the net gain in energy cost-prohibitive. Wind and solar power are effective, but need to be utilized in places where a continuous source of wind and/or sun are constantly available. Moreover, current technology simply does not exist to allow wind and solar power to, by themselves, make a sizable contribution to world energy demand.

In light of the foregoing, it can be seen that a need for improved and as of yet untapped energy generation exists.

### SUMMARY

In accordance with an exemplary embodiment of the present disclosure, an energy generation device is disclosed which includes a reservoir adapted to receive a supply of water, a spring proximate the reservoir, a supply of ice melting agent, a drive shaft connected to the spring, an electric generator connected to the drive shaft, and a processor, the processor adapted to release the supply of calcium chloride when the supply of water in the reservoir is frozen.

In accordance with another aspect of the disclosure, a method of generating energy is disclosed which includes providing a freeze panel in an environment having a temperature below the freezing point of water, filling a reservoir in the freeze panel with water, providing a plurality of springs around the reservoir, the plurality of springs compressing when the water with the reservoir freezes and expands, causing the compressed springs to drive an electric generator, releasing a supply of calcium chloride into the reservoir when the water has frozen into ice, the calcium chloride causing the ice to melt, the melting of the ice causing the plurality of springs to expand, the expanding springs further driving the electric generator, repeating the filling and releasing steps above so as to continuous drive the electric generator and thereby generator energy.

In accordance with yet another aspect of the disclosure, a system for generating energy is disclosed, which may have a plurality of freeze panels provided in an array, each of the freeze panels including a reservoir adapted to receive a supply of water, a spring proximate the reservoir, a supply of ice melting agent, a drive shaft connected to the spring, an electric generator connected to the drive shaft, and a processor, the processor adapted to release the supply of ice melting agent when the supply of water in the reservoir is frozen; a national power grid; a processor adapted to communicate the energy generated by the plurality of freeze panels to the national power grid. These and other aspects and features of the present disclosure will be more readily understood upon reading the following detailed description when taken in conjunction with the accompanying drawings.

### BRIEF DESCRIPTION OF THE DRAWINGS

FIG. 1 is a block diagram depicting a frozen water energy generation system constructed in accordance with the present disclosure.

FIG. 2 schematic illustration of a freeze chamber constructed in accordance with the teachings of the present disclosure.

FIG. 3 is a schematic illustration of a freeze panel having an array of freeze chambers such as that depicted in FIG. 4.

FIG. 4 is a schematic illustration of another embodiment of a freeze chamber constructed in accordance with the present disclosure.

FIG. 5 is a flow chart illustrating a sample sequence of steps which may be practiced according to the method of the present disclosure.

While the following detailed description will made with reference to certain illustrative embodiments, it is to be understood that such embodiments are only exemplary and that other embodiments exist are included within the scope of the equivalents of the present application and appended claims.

### DETAILED DESCRIPTION

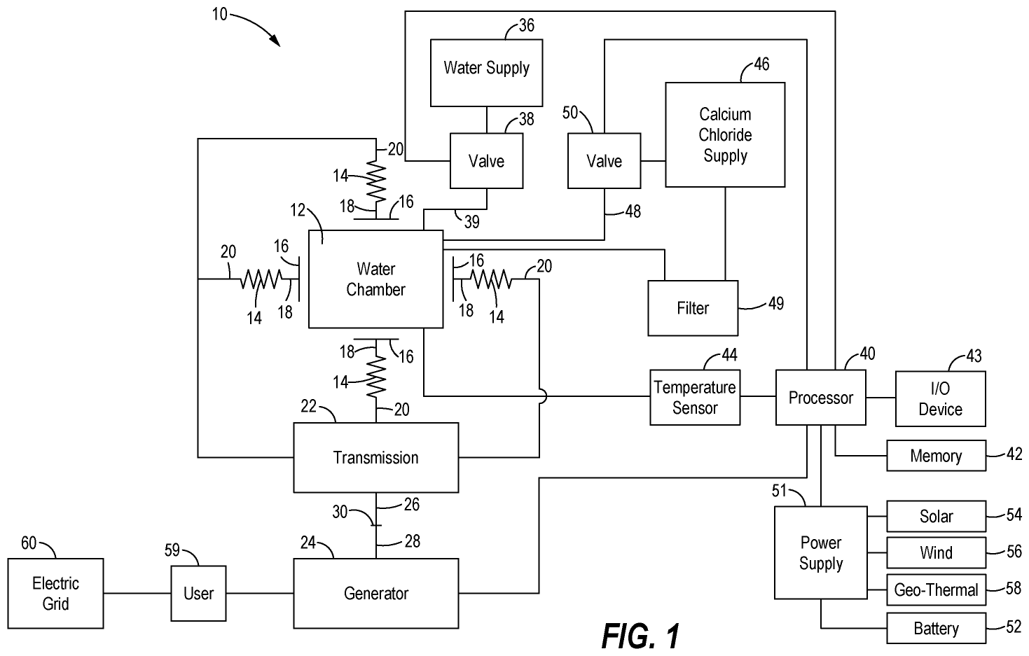

Referring now to the drawings, and with specific reference to FIG. 1, an energy generation system constructed in accordance with the teachings of this disclosure is generally referred to by reference numeral 10. The energy generation system 10 is intended to be used outside in ambient temperatures below the temperature at which water freezes. Accordingly, it may be readily employed in vast areas of the northern and southern hemispheres throughout the calendar year and many other parts of the globe for multiple months a year. In addition it could be used at high altitudes or outer space as well.

As shown in FIG. 1, the system 10 may include one or more water chambers 12. Each water or freeze chamber 12 is designed to have a variable volume such that it has a volume A when filled with water and a volume B when filled with ice. As it is well known that water expands its volume by 11% upon freezing, thus B equals 1.11 A. While it will be described in further detail infra, it is to be understood that the freeze chamber 12 can be any number of shapes and devices including but not limited to balloons, flat trays, parallelepiped chambers and the like.

Adjacent each freeze chamber 12 are a plurality of springs 14. The springs 14 each are adapted to engage the freeze chamber 12 and compress as the freeze chamber 12 expands. For example, the springs 14 may be operatively associated with a plate 16 at proximal ends 18 and themselves positioned proximate to the freeze chamber 12.

In turn, distal ends 20 of the springs 14 may be operatively associated with a transmission 22. The transmission 22 may include any number of mechanical devices to receive the motion generated by the expanding water in the chamber 12 and communicate same to a generator 24. For example, the transmission 22 may include a drive rod 26 connected to an input shaft 28 of the generator 24. Alternatively, the transmission 22 may include a gearbox 30 having an input connected to the drive rod 26, and an output connected to the input shaft 28 of the generator 24. One of ordinary skill in the art while readily understand many other devices such as but not limited to pistons, linear actuators and the like exist for transferring the motion of the expanding freeze chamber 12 to the generator 22.

Also shown in FIG. 1 are a water supply 36 and associated valve 38. In order to fill the freeze chamber 12 with water, the water supply 36 is connected thereto via suitable conduits 39, with the flow of water from water supply 36 to the freeze chamber 12.

Opening and closing of the valve 38 is controlled by a processor 40. The processor 40 may be any readily available computer processor adapted to receive signals, execute code, and generate signals as a result. The processor 40 may be associated with a memory 42 for storing code, as well as a input/output device 43 such as but not limited to a keyboard, joystick, mouse and the like. The processor 40 may be able to communicate with remote locations via the Internet as well be described in further detail herein.

The processor 40 may be in communication with a plurality of sensors 44 provided as part of the energy generation system 10. One of the sensors 44 may be a temperature sensor adapted to monitor the temperature of the water within the freeze chamber 12. Once the temperature of the water within the freeze chamber 12 is monitored to be below the temperature at which water freezes (32° F. or 0° C. under normal circumstances), the sensor 44 sends a corresponding signal to the processor 40. Alternatively, the sensor may be a density sensor, proximity sensor on the like.

Still referring to FIG. 1, the system 10 will be noted to further include a supply 46 of ice melting agent such as calcium chloride (CaCl₂) for melting the ice within the freeze chamber 12. While the supply 46 is noted as calcium chloride, it is to be understood that other additives and chemicals can be used to melt the ice with the freeze chambers 12. For example, sodium chloride, potassium chloride, magnesium chloride, urea, sodium acetate, and others may be used.

Similar to the water supply 36, the supply 46 of ice melting chemical is associated with conduit 48 and a valve 50. Conduit 48 communicates the ice melting chemical 46 to the freeze chamber 12, while the valve 50 turns the flow of ice melting chemical 46 therethrough on and off. In addition, similar to the valve 38, the valve 50 is in electrical communication with the processor 40. More specifically, upon the sensor 44 identifying the water in the freeze chamber 12 as frozen, it sends a corresponding signal to the processor 40. The processor 40 in turn generates a signal and transmits same to valve 50 to open same. This thus results in ice melting chemicals being communicated to the freeze chamber 12 to melt same. Once melted, the water is directed through filter 49 to recycle the ice melting agent for subsequent re-use.

In order to power the processor 40, a number of different power supplies 51 can be employed. Once the freeze/melt cycle begins and the generator 24 is operational, power can be diverted from the generator 24 to power the processor 40. At start-up, other power sources can be used, such as but not limited to batteries 52, solar panels 54, wind turbines 56, geo-thermal powerplants 58 and the like.

Most importantly, once the melt/thaw cycle begins, the power created by the generator 24 can be used by the owner as he or she sees fit. For example, if associated with a dwelling 59, the system 10 can be used to provide electricity, heat or cooling thereto. Any power generated in excess of the needs of the owner can be directed to the national power grid 60 for sale thereto to provide income to the owner.

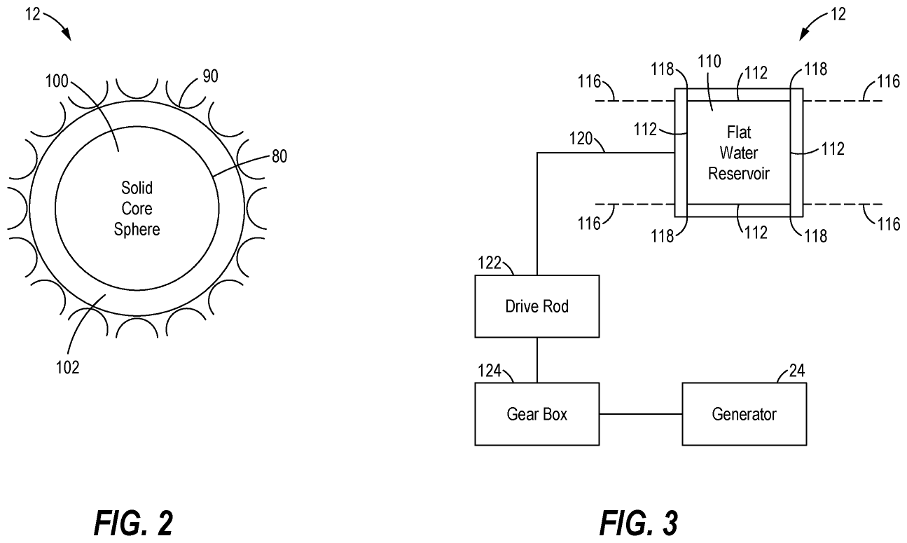

Referring now to FIGS. 2 & 3, two embodiments of the freeze chamber 12 are provided, although myriad others exist. Starting with FIG. 2, the freeze chamber 12 is shown to be spherical in shape. For example, the freeze chamber 12 may be a balloon 80 adapted to be filled with water, expanded upon freezing, and contracted upon melting. Such a spherical shape has the added advantage of enabling springs or other energy collection devices to be positioned around the entirety of the freeze chamber 12 as such a shape expands in all radial directions. As noted such springs or energy collection devices may be leaf springs 90 in addition to coil springs.

As will also be noted in FIG. 2, the freeze chamber 12 may have a solid spherical core 100, with a spherical plenum 102 provided circumferentially there around. Such a design has the advantage of minimizing the volume of water that needs to be frozen to expand the freeze chamber. As it is desirable to freeze and thaw the water and ice as fast and as repetitively as possible to drive the generator 24 as fast as possible, it is desirable to minimize the volume and certain dimensions of the water being frozen. For example, the plenum 102 may be only millimeters or microns thick to enable the water to frozen and thawed in seconds or milliseconds.

In the embodiment of FIG. 3, a linear or axial freeze chamber 12 is provided as opposed to the spherical freeze chamber of FIG. 1. As depicted therein, the freeze chamber 12 may include a base 110, with walls 112 forming a box 114. One or more of the walls 12 maybe axially movable. For example, in the depicted embodiment two of the parallel walls 112 are fixed, and the other two parallel walls 112 are movable, as by being places on rails 116 or the like. Elastomeric seals 118 may be provided between the walls 112 to make a fluid tight seal when closed and being filled with water. As the water freezes, the movable walls 112 slide on the rails 116 with mechanics being provided to capture such movement. For example, springs 120 may be operatively associated with each sliding wall, or a drive rod 122 may be couple to each slidable wall. The springs 120 and/or drive rods 122 may then in turn be connected to the generator 24 to drive same. To maximize mechanical advantage, a gearbox 124 having a relatively high gear ratio may be provided between the drive rod/spring 120/122 and generator 24. One of ordinary skill in the art will readily understand the other shapes and mechanics can be employed to capture the expansion of water as it turns into ice. Such embodiments may include, but are not limited to, water filled pistons, bellows, compressor springs, extension springs, torsion springs, Belleville springs, leaf springs and the likes.

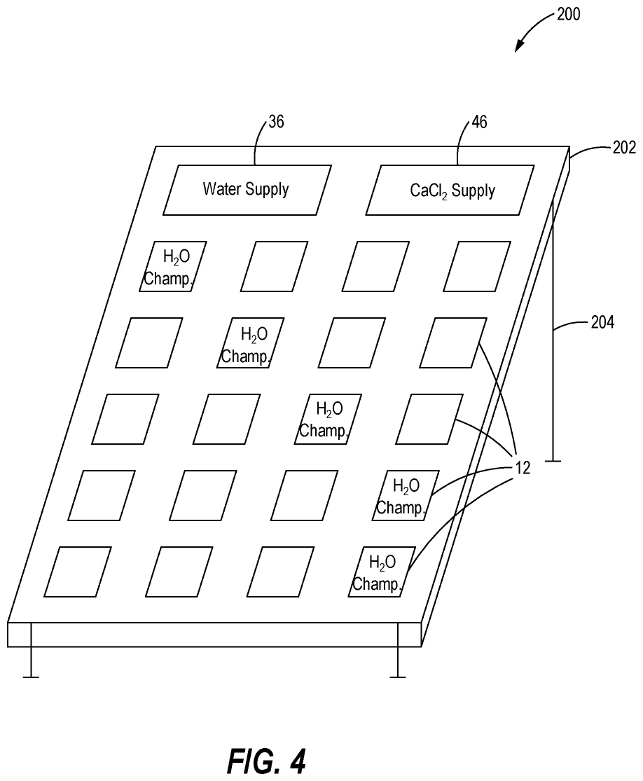

Depending on the dimensions of the freeze chamber 12 and associated mechanics, relatively limited power may be generated if only one freeze chamber 12 is employed. Accordingly, the present disclosure includes providing an array of multiple freeze chambers 12 within a single freeze panel 200 as shown best in FIG. 4. In the depicted embodiment, twenty freeze chambers 12 are provided within a single freeze chamber 12, but it is to be understood that hundreds or thousands or more freeze chambers 12 can be provided within the freeze panel 200 depending on the size of the freeze chambers 12 and the desired power output. The freeze panel 200 may be sized to provide sufficient power to supply a single family dwelling with adequate power, heat and cooling. Alternatively, large arrays or grids of freeze panels 200 can be installed in a public utility to supply power to a neighborhood, municipality or back to the national power grid 10.

As will also be noted in FIG. 4, the freeze panel 200 is provided in a manner resembling well known solar panels. As solar panels have become readily accepted for installation on roofs of single family homes, or other locations, the freeze panel 200 can be similarly installed using a housing 202 and/or legs 204. Moreover, as solar panels are only usually when adequate sunshine is available, a combination solar panel/freeze panel could be employed in locales where seasonal weather changes dictate the type of power generation that can be employed.

In an alternative embodiment, some or all of the power for the power supply may be used to melt or assist with melting the ice in the freeze chamber 12. For example, if the calcium chloride is not melting the ice sufficiently fast, perhaps due to very low ambient temperatures, power from the solar panel 54 on the like can be used to power a melting device such as but not limited to a resistive heater, a microwave, a mechanical actuator on the like to facilitate and expedite the melting of the ice.

### INDUSTRIAL APPLICABILITY

In operation, the teachings of the present disclosure may find applicability in many industries. For example, the freeze panel 200 could take advantage of cold ambient air temperatures to generate energy and power for a given home to which it is electrically connected. Alternatively, the freeze panel 200 could be provided in an array with many other freeze panels to generate sufficient power to supply energy to the energy grid 10.

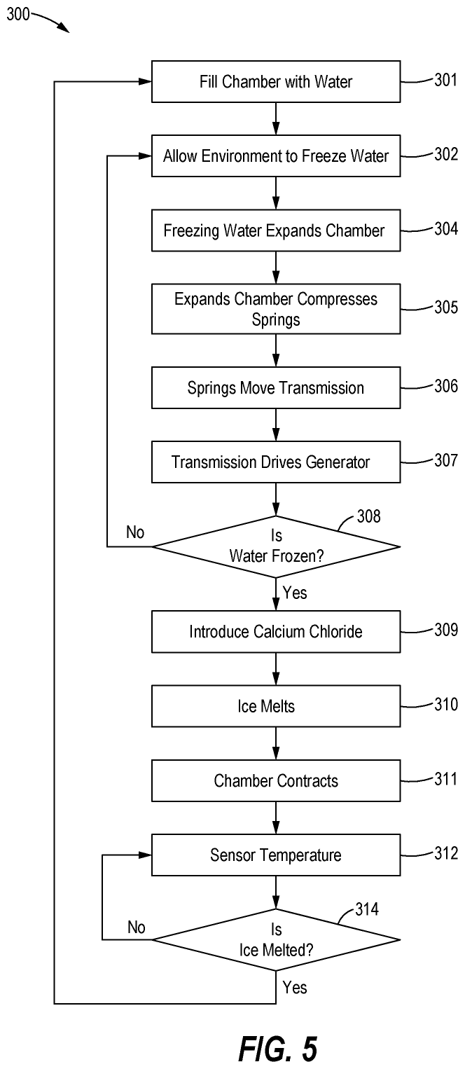

Referring now to FIG. 5, a method 300 of generating energy according to the present disclosure is depicted in flow chart format. Starting with a block 301, the water chamber 12 is filled with water. As the water chamber 12 is placed outside or otherwise exposed to air temperatures below the temperature at which water freezes, the water in the chamber 12 freezes in a block 302. When the water in the chamber 12 freezes, the water expands its volume and in turn expands the chamber in a block 304.

As the chamber is surrounded or otherwise proximate to spring 14, the expansion of the water chamber 12 causes the springs 14 to compress as shown in a block 305. Since the springs 14 are mechanically coupled to the transmission 22, the compression of the springs 14 causes the transmission 22 to move as depicted in block 306, with the moving transmission 22 in turn driving the generator 24 as shown in block 307.

In concert with the generator 24 moving, the processor 40 receives signals from the sensor 44 indicating whether the water in the chamber 12 is frozen as shown in block 308. If the answer is affirmative, the process sends a signal to valve to cause calcium chloride, or other ice melter, to be introduced into the chamber 12. This is depicted in block 309. The water is thus caused to melt as shown in block 310. As the ice melts, the volume in the chamber 12 contracts as shown in block 311.

Returning back to block 308, if the processor 40 determined the water is not yet completely frozen, the method returns to block 302 for further monitoring.

Once the ice melts and the chamber 12 contracts in block 311, the processor 40 senses the temperature of the water in the chamber 12 in block 312 and determines if the ice is completely melted as shown by block 314. If yes, the chamber 12 is filled with water again back at block 301. If no, the method allows the calcium chloride further time to melt the ice.

From the foregoing, it can be seen that the present disclosure provides an effective way to utilize the naturally occurring cold air and ambient temperatures around the globe to generate energy. Not only can such a device and method power homes and other dwellings, but if done in sufficient scale can be used to add power to the national power grid, all without negatively impacting the environment.

1. A energy generation device, comprising:
a reservoir adapted to receive a supply of water;
a spring proximate the reservoir;
a supply of ice melting agent;
a drive shaft connected to the spring;
an electric generator connected to the drive shaft; and
a processor, the processor adapted to release the supply of ice melting agent when the supply of water in the reservoir is frozen.

2. The energy generation device of claim 1, wherein the ice melting agent is calcium chloride.

3. The energy generation device of claim 1, wherein the ice melting agent is sodium chloride.

4. The energy generation device of claim 1, wherein the ice melting agent is potassium chloride.

5. The energy generation device of claim 1, wherein the ice melting agent is magnesium chloride.

6. The energy generation device of claim 1, wherein the ice melting agent is urea.

7. The energy generation device of claim 1, wherein the ice melting agent is sodium acetate.

8. The energy generation device of claim 1, further including a filter adapted to remove the ice melting agent from the water after the ice has melted.

9. The energy generation device of claim 1, further including a power supply adapted to provide power to the processor.

10. The energy generation device of claim 9, wherein the power supply uses at least one of solar power, wind power, geothermal power and battery power.

11. A method of generating energy, comprising:
providing a freeze panel in an environment having a temperature below the freezing point of water;
filling a reservoir in the freeze panel with water;
providing a plurality of springs around the reservoir, the plurality of springs compressing when the water with the reservoir freezes and expands;
causing the compressed springs to drive an electric generator;
releasing a supply of calcium chloride into the reservoir when the water has frozen into ice, the calcium chloride causing the ice to melt, the melting of the ice causing the plurality of springs to expand, the expanding springs further driving the electric generator;
repeating the filling and releasing steps above so as to continuous drive the electric generator and thereby generator energy.

12. A system for generating energy, comprising:
a plurality of freeze panels provided in an array, each of the freeze panels including a reservoir adapted to receive a supply of water, a spring proximate the reservoir, a supply of ice melting agent, a drive shaft connected to the spring, an electric generator connected to the drive shaft, and a processor, the processor adapted to release the supply of ice melting agent when the supply of water in the reservoir is frozen;
a national power grid;
a processor adapted to communicate the energy generated by the plurality of freeze panels to the national power grid.

13. The system for generating energy of claim 12, wherein the ice melting agent is calcium chloride.

14. The system for generating energy of claim 12, wherein the ice melting agent is sodium chloride.

15. The system for generating energy of claim 12, wherein the ice melting agent is potassium chloride.

16. The system for generating energy of claim 12, wherein the ice melting agent is magnesium chloride.

17. The system for generating energy of claim 12, wherein the ice melting agent is urea.

18. The system for generating energy of claim 12, wherein the ice melting agent is sodium acetate.

19. The system for generating energy of claim 12, further including a power supply adapted to provide power to the processor.

20. The system for generating energy of claim 19, wherein the power supply uses at least one of solar power, wind power, geothermal power and battery power.
